(19) United States
(12) Patent Application Publication
(10) Pub. No.: US 2010/0028016 A1
(43) Pub. Date: Feb. 4, 2010

(54) Optical Signal Processing Device

(75) Inventor: Tuomo Von Lerber, Helsinki (FI)

Correspondence Address: VENABLE LLP, P.O. BOX 34385, WASHINGTON, DC, 20043-9998, US

(73) Assignee: PERLOS TECHNOLOGY OY, Vantaa (FI)

(21) Appl. No.: 11/920,228

(22) PCT Filed: May 12, 2005
(86) PCT No.: PCT/FI2005/050156

§ 371 Date: Nov. 13, 2007

(51) Int. Cl. H04B 10/00

(52) U.S. Cl. 398/138

(57) ABSTRACT

A signal processing device including a light source to emit light at a wavelength which is substantially equal to the carrier wavelength of an optical input signal. An optical resonator provides a filtered signal by optical filtering of the optical input signal. The optical resonator is non-matched with the carrier wavelength of the optical input signal. An optical combiner combines the filtered signal with the emitted light to form an optical output signal. The signal processing device may be adapted to recover the clock frequency of a modulated input signal. The intensity of the output signal exhibits periodic variations at the clock frequency when the resonator is adjusted at least approximately to the predetermined sideband of the modulated input signal.

### FIELD OF THE INVENTION

The present invention relates to optical signal processing.

### BACKGROUND OF THE INVENTION

Signals have been traditionally processed in the electrical domain. However, conversion of optical signals to electrical signals is non-trivial at high modulation frequencies. Optical processing of optical signals provides an efficient and cost-effective approach at high modulation frequencies, e.g. when the modulation frequency is in the order of 40 GHz or higher.

Optical signal processing may be used e.g. for the recovery of clock frequency from an optical data signal.

US Patent publication 2001/0038481A1 discloses an apparatus for extraction of optical clock signal from an optical data signal. The apparatus comprises a non-linear optical element coupled to receive an optical data signal, said non-linear element generating a chirped signal based on the optical data signal, and an optical frequency discriminator coupled to receive said chirped signal from the non-linear element, the discriminator generating an optical clock signal based on chirped frequency components of the chirped signal.

An article “Optical Tank Circuits Used for All-Optical Timing Recovery” by M. Jinno, T. Matsumoto, IEEE Journal of Quantum Electronics, Vol. 28, No. 4 April 1992 pp. 895-900, discloses a timing recovery scheme based on an optical resonator. When processing an optical signal which is modulated according to the return-to-zero format, one of the resonance peaks of the optical resonator is adjusted to the center frequency of the incoming optical data stream, and the separation between the pass bands of the optical resonator is selected to be equal to the clock frequency. The spectral components which correspond to the center frequency of the signal and to the sideband frequencies corresponding to the modulation of the signal are transmitted, which results in the recovery of the optical clock signal.

### SUMMARY OF THE INVENTION

It is an object of the present invention to provide a device for processing of optical signals. It is also an object of the present invention to provide a method for processing of optical signals. It is a further object of the present invention to provide a device and a method for spectral analysis of optical signals.

According to a first aspect of the invention, there is a device for processing of an optical input signal, which optical input signal has one or more carrier wavelengths, said device comprising at least:
an optical resonator to provide a filtered signal by optical filtering of said optical input signal, said optical resonator being non-matched with a predetermined carrier wavelength of said optical input signal,
one or more light sources to emit light at one or more wavelengths such that at least one wavelength of the emitted light is substantially equal to said predetermined carrier wavelength of said optical input signal, and
an optical combiner to combine said filtered signal with said emitted light to form an optical output signal.

According to a second aspect of the present invention, there is a method for processing of an optical input signal, which optical input signal has one or more carrier wavelengths, wherein said method comprises at least:
optical filtering of said optical input signal to provide a filtered signal by using an optical resonator, said resonator being non-matched with a predetermined carrier wavelength of said optical input signal,
providing emitted light by using a light source at a wavelength which is substantially equal to said predetermined carrier wavelength of said optical input signal,
optically combining said filtered signal with said emitted light to form an optical output signal.

According to a third aspect of the present invention, there is a device for analyzing wavelength components an optical input signal, said device comprising at least:
a tunable optical resonator to provide a filtered signal by optical filtering of said optical input signal,
a light source to emit light a wavelength in the vicinity of a wavelength range of said optical input signal to be analyzed,
a combiner to optically combine said filtered signal with said emitted light to form an optical output signal, and
at least one detector to monitor the amplitude of beating of said optical output signal.

According to a fourth aspect of the present invention, there is a method for analyzing wavelength components an optical input signal, said method comprising at least:
optical filtering of said optical input signal to provide a filtered signal by using a tunable optical resonator,
providing emitted light having a wavelength in the vicinity of a wavelength range of said optical input signal to be analyzed,
optically combining said filtered signal with said emitted light to form an optical output signal, and
monitoring the amplitude of beating of said optical output signal.

An optical resonator is a device which has a capability to wavelength-selectively store optical energy carried at one or more wavelengths. The term non-matched means that the optical resonator is adapted to provide one or more optical pass bands such that the predetermined carrier wavelength does not coincide with the pass bands, i.e. the carrier wavelength is outside the wavelength range of each pass band of the resonator.

The optical input signal may be modulated. Consequently, it may comprise a sideband at a wavelength which is different from the carrier wavelength of said input signal. The optical resonator may be matched with the wavelength of the sideband, which means that at least one pass band of the optical resonator coincides at least approximately with the wavelength of the sideband such that the optical resonator is adapted to store optical energy carried at the wavelength of the sideband. The output signal is formed by the combination of the sideband signal and the emitted light, and consequently it exhibits a beat at a frequency which is proportional to the difference between the sideband wavelength and the wavelength of the emitted light.

In an embodiment, the signal processing device and the method according to the present invention may be used to process simultaneously, i.e. parallel in time domain, a plurality of optical signals having different carrier wavelengths and/or data rates and/or different formats of modulation.

Because the optical resonator has the capability to store optical energy, it may provide a filtered signal also during periods when the optical input signal does not change its state.

In an embodiment, the signal processing device may be used as a clock signal recovery device to recover at least one clock signal associated with the optical input signal.

In an embodiment, the signal processing device may be applied to simultaneously recover a plurality of different clock signals associated with data transmitted at different optical channels, i.e. at different carrier wavelengths.

In the above-mentioned method by Jinno et al. the separation between the adjacent optical channels has to correspond to an integer multiple of the clock frequency. When compared with the method by Jinno et al., the method according to the present invention may also be adapted to process signals in which the separation between the adjacent optical channels does not correspond to an integer multiple of the clock frequency.

The recovered clock signal decays when the optical input signal does not change its state. Assuming that the optical resonators used in the method by Jinno et al. and in the method according to the present invention have equal time constants, the clock signal recovered using the method according to the present invention decays at a slower rate than the clock signal recovered by the method by Jinno et al.

The implementation of the devices and the methods according to the present invention requires a relatively small number of optical components, providing thus simplicity and savings in cost.

The embodiments of the invention and their benefits will become more apparent to a person skilled in the art through the description and examples given herein below, and also through the appended claims.

### BRIEF DESCRIPTION OF THE FIGURES

In the following examples, the embodiments of the invention will be described in more detail with reference to the appended drawings, in which

FIG. 1 shows a block diagram of a signal processing device,

FIG. 2 shows schematically an optical resonator based on a cavity between reflectors,

FIG. 3a shows by way of example a return-to-zero modulated data signal consisting of a sequence of rectangular pulses, and a clock signal associated with said data signal,

FIG. 3b shows the frequency decomposition of the data signal according to FIG. 3a,

FIG. 3c shows an optical input signal modulated by the data signal according to FIG. 3a,

FIG. 4 shows schematically filtering and combination of optical signals in the wavelength domain,

FIG. 5a shows by way of example a return-to-zero modulated optical input signal, the temporal evolution of a sideband signal and the temporal evolution of an output signal corresponding to said input signal,

FIG. 5b shows by way of example an output signal which is stabilized with respect to the beat amplitude,

FIG. 6 shows a block diagram of a signal processing device comprising a wavelength feedback loop,

FIG. 7 shows a block diagram of a signal processing device comprising a light source which is coupled to a second resonator,

FIG. 8 shows schematically an optical resonator based on a fiber optic Bragg grating,

FIG. 9 shows schematically an optical resonator based on two Bragg gratings,

FIG. 10a shows schematically an optical resonator based on a micro ring,

FIG. 10b shows schematically an optical resonator based on a plurality of optically coupled micro rings,

FIG. 11 shows schematically an optical resonator based on a photonic microstructure,

FIG. 12 shows a block diagram of a signal processing device, said device comprising a polarization controller to control the polarization of the optical input signal,

FIG. 13 shows a block diagram of a signal processing device, said device comprising an arrangement to provide insensitivity with regard to the polarization of a primary optical input signal,

FIG. 14 shows a block diagram of a signal processing device, said device comprising pre-processing means to generate further frequency components based on a primary signal, which does not have significant spectral components corresponding to clock frequencies,

FIG. 15 shows a block diagram of a signal processing device, said device comprising a delay unit and an optical combiner to generate further frequency components based on a primary signal, which does not have significant spectral components corresponding to clock frequencies,

FIG. 16 shows a block diagram of a signal processing device, said device comprising means to stabilize a fluctuating amplitude of the optical output signal and to reshape its waveform,

FIG. 17 shows schematically filtering and combination of an optical input signal, the separation between adjacent pass bands of the resonator being smaller than the separation between the carrier wavelength and the sideband wavelength,

FIG. 18 shows schematically filtering of an optical input signal consisting of data transmitted at three different optical channels,

FIG. 19 shows a block diagram of a signal processing device, which device comprises at least two light sources, each light source being adapted to emit light at one or more wavelengths,

FIG. 20 shows a block diagram of the signal processing device adapted for spectral analysis of the optical input signal, and

FIG. 21 shows schematically spectral analysis of the optical input signal, said analysis being based on recording the beat amplitude as a function of the beat frequency.

### DETAILED DESCRIPTION OF THE INVENTION

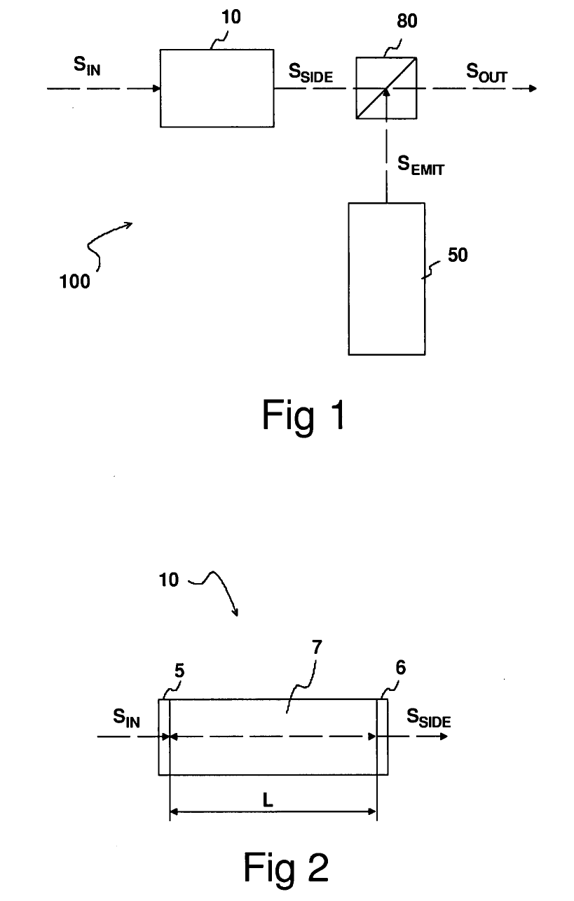

FIG. 1 shows a block diagram of the signal processing device 100. An input signal S_{IN} is filtered by a first resonator 10 to provide a filtered signal S_{SIDE}. The signal filtered using the first resonator 10 is herein called as the sideband signal. The sideband signal S_{SIDE} is subsequently combined with emitted light S_{EMIT} in an optical combiner 80 to provide an output signal of the signal processing device 100. The emitted light S_{EMIT} is provided by a light source 50. The light source 50 is advantageously adapted to emit continuous wave light. Advantageously, the emitted light S_{EMIT} is at least partially coherent. The light source 50 may be a laser.

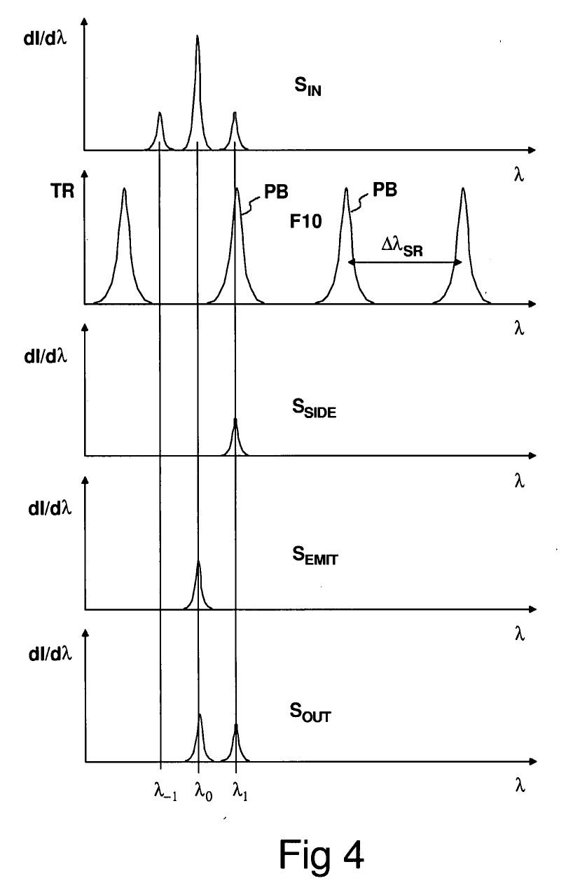

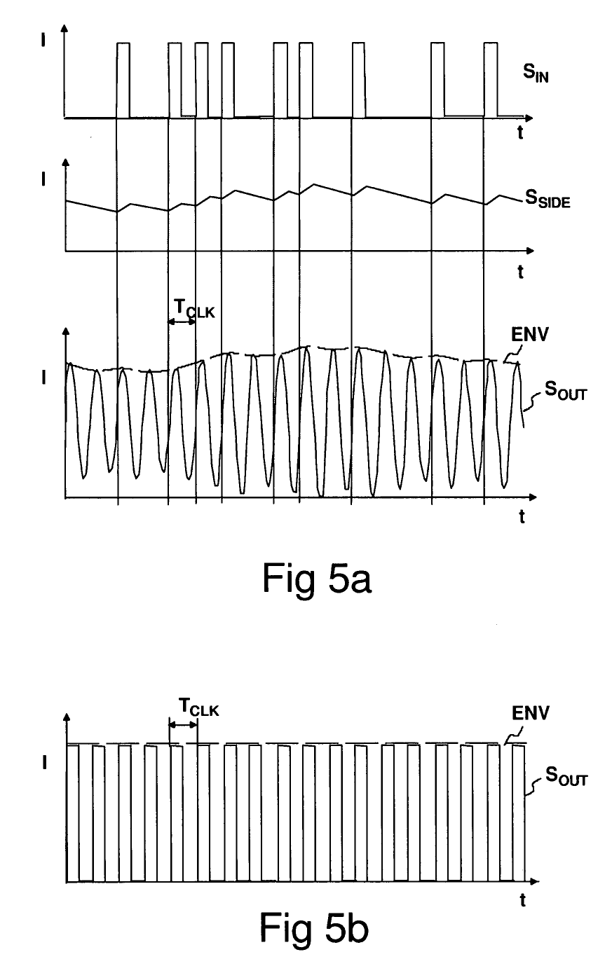

Referring to FIG. 2, an optical resonator 10 may be implemented using an optical cavity 7 defined between two reflectors 5, 6. The optical length of the cavity 7 is L. The optical length L is equal to the distance between the reflectors 5, 6 multiplied by the refractive index of the cavity medium. The resonator 10 acts as a band pass filter having a plurality of pass bands (see the second curve from the top in FIG. 4). The reflectors 5, 6 may be e.g. planar or spherical reflective surfaces. In case of planar reflective surfaces, adjacent pass bands in the vicinity of a wavelength λ are separated by a separation range Δλ_{SR} given by

$$Δ {λ}_{SR} = \frac{{λ}^{2}}{2 L} . \qquad ( 1 )$$

The separation range Δν_{SR} may also be expressed in the frequency domain:

$$Δ {v}_{SR} = \frac{c}{2 L} , \qquad ( 2 )$$

where c is the speed of light in vacuum.

The separation range Δν_{SR} may be substantially constant over a predetermined wavelength range. In order to implement a constant separation range, the cavity 7 may be non-dispersive. Alternatively, the resonator 10 may comprise further elements to compensate dispersion. On the other hand, the resonator 10 may also be dispersive to provide a varying separation range Δν_{SR}. Such a resonator may be used e.g. in applications where the pass bands should coincide with several optical channels which have non-equal separations in the frequency domain.

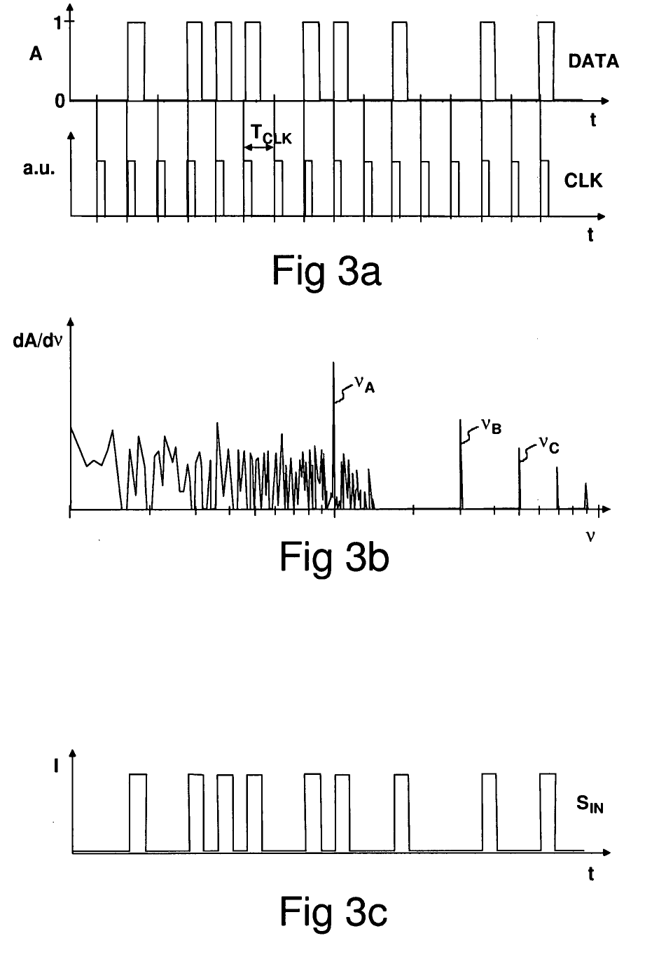

Referring to the upper curve of FIG. 3a, a data signal DATA may consist of a sequence of rectangular pulses. The data signal DATA shown in FIG. 3a is modulated in the return-to-zero (RZ) format. t denotes time and A denotes amplitude. At this stage the data signal DATA may be an optical signal or it may be an electrical signal. The data signal assumes values 0 or 1. In a remote optical transmitter (not shown), the timing of the data pulses is controlled by a real or hypothetical sequence of clock pulses CLK, which are shown by the lower curve of FIG. 3a. The time period between two consecutive clock pulses is T_{CLK}. The frequency ν_{CLK} of the clock is equal to 1/T_{CLK}, respectively.

FIG. 3b shows the frequency decomposition of the data signal DATA according to FIG. 3a. ν denotes frequency. The ordinate and the abscissa values are shown in logarithmic scale. The frequency decomposition exhibits several distinctive spectral peaks ν_{A}, ν_{B}, ν_{C}, . . . . In this case the spectral position of the peak VA is equal to the clock frequency ν_{CLK} associated with the data sequence according to FIG. 3a.

FIG. 3c shows schematically an optical input signal S_{IN} having a carrier wavelength λ₀. I denotes intensity. The optical input signal S_{IN} may be formed in the remote optical transmitter (not shown) by multiplying a continuous optical signal having wavelength λ₀ with the data signal DATA. The electric field of the optical input signal S_{IN} is modulated according to the data signal DATA, but it comprises also the optical frequency (=c/nλ₀) corresponding to the wavelength λ₀, which wavelength is herein called as the carrier wavelength. Said optical frequency is herein called as the carrier frequency. n is the index of refraction.

The uppermost curve of FIG. 4 shows the spectral composition of the optical input signal S_{IN} in the wavelength domain. In this example the optical input signal S_{IN} consists of data transmitted at one optical channel only. The spectrum of the optical input signal S_{IN} exhibits a central peak at the carrier wavelength λ₀. Due to the modulation of the signal there are typically at least two side peaks at the wavelengths λ₋₁ and λ₁. The peak at λ₋₁ is blue-shifted (having a shorter wavelength) and the peak at λ₁ is red-shifted (having a longer wavelength) with respect to the carrier wavelength λ₀. The spectrum may comprise further spectral peaks, but they have been omitted for the sake of clarity of FIG. 4.

The difference λ₁−λ₀, and the difference λ₀−λ₋₁ depend on the clock frequency ν_{CLK}. There may be more spectral peaks than those at λ₋₁ and λ₁. Based on the known format of modulation and the known form of the data, the person skilled in the art is able to select which one(s) of the side peaks corresponds to the desired filtered frequency, e.g. to the clock frequency.

Referring to the second curve F10 from the top in FIG. 4, the spectral transmittance of the first resonator 10 (FIGS. 1 and 2) may have several adjacent pass bands PB. The separation of the pass bands PB is equal to the separation range Δλ_{SR}. At least one of the pass bands PB is tuned at least approximately to the wavelength λ₁ such that the carrier wavelength λ₀ is substantially not transmitted, i.e. the spectral component at the carrier wavelength λ₀ is substantially rejected by the first resonator 10. TR denotes the transmittance, i.e. the ratio of the transmitted intensity to the input intensity. Alternatively, at least one of the pass bands PB may be tuned at least approximately to the wavelength λ₋₁. Yet, the pass bands PB may be tuned simultaneously to the both sideband wavelengths λ₋₁ and λ₁, provided that the separation range Δλ_{SR} of the first resonator 10 or its integer multiple matches with the separation between the sideband wavelengths λ₋₁ and λ₁.

Referring to the third curve S_{SIDE} from the top in FIG. 4, only the sideband of the original input signal S_{IN} is transmitted through the first resonator 10, to provide the sideband signal S_{SIDE}.

Referring to the fourth curve from the top in FIG. 4, the light source 50 (FIG. 1) is adapted to provide emitted light S_{EMIT} at the wavelength λ₀. Advantageously, the intensity of the emitted light S_{EMIT} is substantially constant.

Referring to the lowermost curve in FIG. 4, the emitted light S_{EMIT} is combined with the sideband signal S_{SIDE} by the combiner 80 (FIG. 1) to provide the output signal S_{OUT}. The output signal S_{OUT} has a spectrum consisting of two peaks at the wavelengths λ₀ and λ₁. The output signal S_{OUT} may have further spectral peaks and/or components.

The carrier wavelength λ₀ corresponds to a carrier frequency ν₀ which is equal to c/nλ₀. λ₀ refers to the wavelength in vacuum and n is the index of refraction. The sideband wavelength λ₁ corresponds to a sideband frequency ν₁ which is equal to c/nλ₁. The intensity of the output signal S_{OUT} exhibits now periodic variations, i.e. beat in a frequency which is equal to the difference between the sideband frequency ν₁ and the carrier frequency ν₀. Said difference is equal to the clock frequency ν_{CLK}. The output signal S_{OUT} may be used as an optical clock signal.

The electric field E_{OUT} of the optical output signal S_{OUT} is a superposition

E_{OUT}(t)=E₁ exp(j2πν₁t)+E₀ exp(j2πν₀t), (3)

where E₁ is the amplitude of the field of the sideband signal S_{SIDE} after the combiner 80 and E₀ is the amplitude of the electric field of the emitted light S_{EMIT} after the combiner 80. The intensity I_{OUT} of the output signal is given by

I_{OUT}(t)=E_{OUT}(t)E_{OUT}*(t) (4)

I_{OUT}(t)=E₁²+E₀²+2E₁E₀ cos [2π(ν₁−ν₀)t] (5)

I_{OUT}(t)=E₁²+E₀²+2E₁E₀ cos(2πν_{CLK}t) (6)

The output intensity exhibits a substantially sinusoidal beat at the frequency ν₁−ν₀, i.e. at the frequency ν_{CLK} of the clock. The last term in the equation (5) is herein called as the beating term.

The combiner 80 may be a semitransparent reflector, a beam splitter or a beam coupler based on fiber optics, an integrated optical Y-coupler, a directional coupler, a filter, a grating-based coupler, a polarizer or a spatial multiplexer. The combiner 80 may also be a combination of these and/or related optical elements. The output signal S_{OUT} is a vector sum of the sideband signal S_{SIDE} and the emitted light S_{EMIT}. When the sideband signal S_{SIDE} and the emitted light S_{EMIT} are combined by the beam combiner 80, the polarization (i.e. the orientation of polarization) of the sideband signal S_{SIDE} may be at any angle with respect to the polarization of the emitted light S_{EMIT}. Parallel polarization provides maximum beating amplitude.

Distinctive beating may be observed when the polarization of the emitted light S_{EMIT} may be adjusted to be parallel to the polarization of the sideband signal S_{SIDE}. The intensity of the sideband signal S_{SIDE} is typically low, but the beating term in the equation (5) may be amplified by increasing the amplitude E₀ of the electric field of the emitted light S_{EMIT}, i.e. by increasing intensity of the emitted light S_{EMIT}.

On the other hand, the relative contribution of the beating term may be maximized by setting the intensity of the emitted light S_{EMIT} to be approximately equal to the average intensity of the sideband signal S_{SIDE}, i.e. by setting E₁≈E_{0.}

The relative intensities of the emitted light S_{EMIT} and the sideband signal S_{SIDE} may be adjusted e.g. by adjusting the power or current of a laser, or by adjusting the angular orientation of a polarizer positioned in the optical path.

The optical resonator has a capability to store optical energy. This phenomenon is now discussed with reference to the resonator according to FIG. 2. However, the discussion is relevant also regarding other types of optical resonators. Photons coupled into the resonator according to FIG. 2 pass, in average, several times back and forth between the reflectors 5, 6 before escaping from the cavity 7. Thus, the resonator 10 can sustain its state for some time regardless of perturbations of the optical input signal S_{IN}. The time constant τ of the resonator 10 is given by the equation

$$τ = \frac{L}{- c ln ( r )} , \qquad ( 7 )$$

where L is the optical length of the cavity 7 (physical distance multiplied by the refractive index) between the reflectors 5, 6, c is the speed of light in vacuum and r is the reflectance of the reflectors 5, 6. For example, by selecting the parameters r=0.99 and L=1 mm, the time constant τ of the resonator is 332 picoseconds.

Advantageously, the time constant τ is selected to be greater than or equal to the average time period during which the optical input signal S_{IN} does not change its state. In case of return-to-zero (RZ) signals, the time constant τ is advantageously selected to be greater than or equal to the average time period during which the optical input signal S_{IN} remains at zero.

FIG. 5a shows the temporal behavior of the sideband signal S_{SIDE} and the output signal S_{OUT} corresponding to a return-to-zero-modulated input signal S_{IN}. The uppermost curve shows the input signal S_{IN}. The second curve from the top shows the temporal behavior of the sideband signal S_{SIDE}. The intensity of the sideband signal S_{SIDE} decreases when no optical energy is delivered to the first resonator 10, i.e. the first resonator 10 is discharged. The intensity of the sideband signal S_{SIDE} increases when optical energy is delivered to the first resonator 10, i.e. the first resonator 10 is charged. The lowermost curve shows the temporal behavior of the output signal S_{OUT}. The output signal S_{OUT} exhibits a beat at the recovered clock frequency ν_{CLK}. The envelope ENV of the output signal S_{OUT} fluctuates according to the fluctuating sideband signal S_{SIDE}. It is emphasized that although the envelope ENV of the output signal intensity fluctuates, the amplitude of the beating of the output signal S_{OUT} approaches zero only if the input signal S_{IN} is at zero for a long time. Thus, the beating output signal S_{OUT} can be used as an uninterrupted clock signal.

It is emphasized that because the intensity of the emitted light S_{EMIT} remains substantially constant, the beat term in the equation (5) decreases only at the same rate as the amplitude of the sideband signal S_{SIDE}. Thus, the decay of the beat signal takes place at a slower rate than, for example, in the above-mentioned method by Jinno et al.

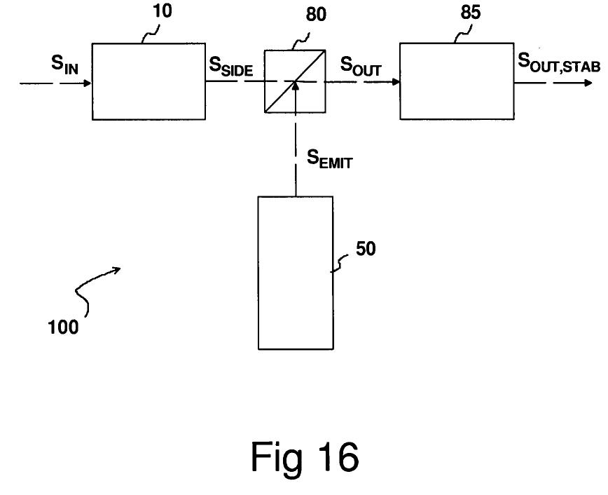

The signal processing device 100 may further comprise an output stabilization unit to provide an output signal which is stabilized with respect to the beat amplitude, and reshaped (See FIG. 16 and the related discussion). FIG. 5b shows, by way of example an output signal S_{OUT} which is stabilized with respect to the beat amplitude.

The recovered clock signal is accurate only when the wavelength of the emitted light S_{EMIT} is equal to the carrier wavelength λ₀ of the input signal S_{IN}. The light source 50, e.g. a laser may comprise a wavelength reference for locking the wavelength to a predetermined carrier wavelength λ₀. The wavelength reference may be an internal wavelength reference. However, the approach of using the wavelength standard is applicable only when the carrier wavelength of the input signal S_{IN} is stable.

The signal processing device 100 may comprise means to set the wavelength of the emitted light S_{EMIT} to be equal to the carrier wavelength of the input signal S_{IN}.

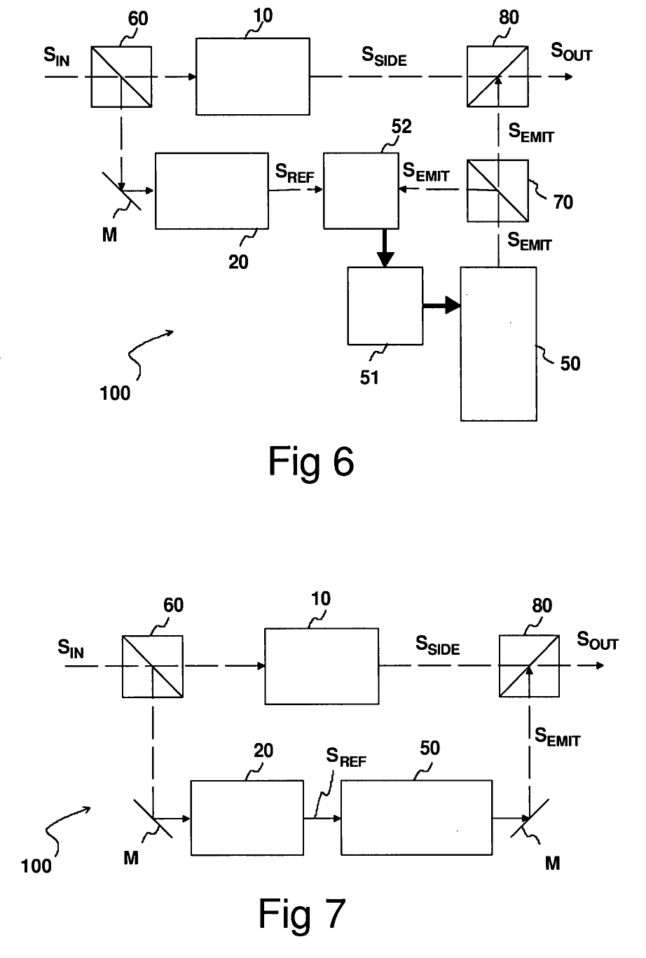

Referring to FIG. 6, the wavelength of the emitted light S_{EMIT} may be set to the carrier wavelength λ₀ using a wavelength feedback loop. A part of the input signal S_{IN} is separated using a beam splitter 60 and coupled through a second resonator 20 to recover the carrier wavelength λ₀. The second resonator 20 is tuned at least approximately to the carrier wavelength λ₀. Only those components of the input signal S_{IN} which are at the carrier wavelength λ₀ or in the vicinity of said carrier wavelength λ₀ are passed through the second resonator 20 to provide a reference signal S_{REF}. A part of the emitted light S_{EMIT} may be separated by a second beam splitter 70. The wavelength of the reference signal S_{REF} is compared with the wavelength of the emitted light S_{EMIT} in a wavelength comparator 52. The wavelength comparator provides a control signal to a wavelength tuner 51. The wavelength tuner 51 adjusts the wavelength of the light source 50, e.g. a laser, such that the wavelength of the emitted light S_{EMIT} becomes equal to the wavelength of reference signal S_{REF}. Mirrors M may be used to direct light. The second resonator 20 may be implemented in the same way as the first resonator 10.

The second resonator 20 may also be replaced with a wavelength-selecting component such as a wavelength selective filter, grating based device, monochromator, an arrayed waveguide grating, a periodic microstructure, a stack of thin films, a wavelength-selective absorbing filter, a filter based on non-linear optical phenomena, or a combination thereof.

The wavelength comparator 52 may be implemented e.g. by combining the reference signal S_{REF} and the emitted light S_{EMIT} and monitoring the beat frequency of the combined signal.

Referring to FIG. 7, the light source 50 may also be an optical amplifier or an arrangement comprising several optical amplifiers. The optical amplifier 50 may be e.g. an injection seeded laser, a semiconductor optical amplifier, or an erbium-doped fiber amplifier, or another light-amplifying device known by the person skilled in the art. The wavelength of the emitted light S_{EMIT} may be set to the carrier wavelength λ₀ using an optical amplifier 50. A part of the input signal S_{IN} is separated by a beam splitter 60 and coupled through a second resonator 20 to recover the carrier wavelength λ₀. The second resonator 20 is tuned at least approximately to the carrier wavelength λ₀. Only those components of the input signal S_{IN} which are at the carrier wavelength λ₀ or in the vicinity of said carrier wavelength λ₀ are passed through the second resonator 20 to provide a reference signal S_{REF}. The reference signal S_{REF} is coupled to the light source 50, which subsequently provides emitted light S_{EMIT} at the wavelength λ₀. Mirrors M may be used to direct light. The second resonator 20 may be implemented in the same way as the first resonator 10.

The first resonator 10 and/or the second resonator 20 may be implemented using optical resonators known by the person skilled in the art. Suitable optical resonators are disclosed e.g. in an article “Optical Tank Circuits Used for All-Optical Timing Recovery” by M. Jinno, T. Matsumoto, IEEE Journal of Quantum Electronics, Vol. 28, No. 4 April 1992 pp. 895-900, herein incorporated by reference.

Referring to the resonator shown in FIG. 2, the first resonator 10 and/or the second resonator 20 may be tuned by adjusting the distance between the reflectors 5, 6. The wavelength tuning of the pass bands PB may be performed by methods known by the person skilled in the art. The methods comprise e.g. controlling temperature, pressure, electric field, voltage, current or mechanical deformation.

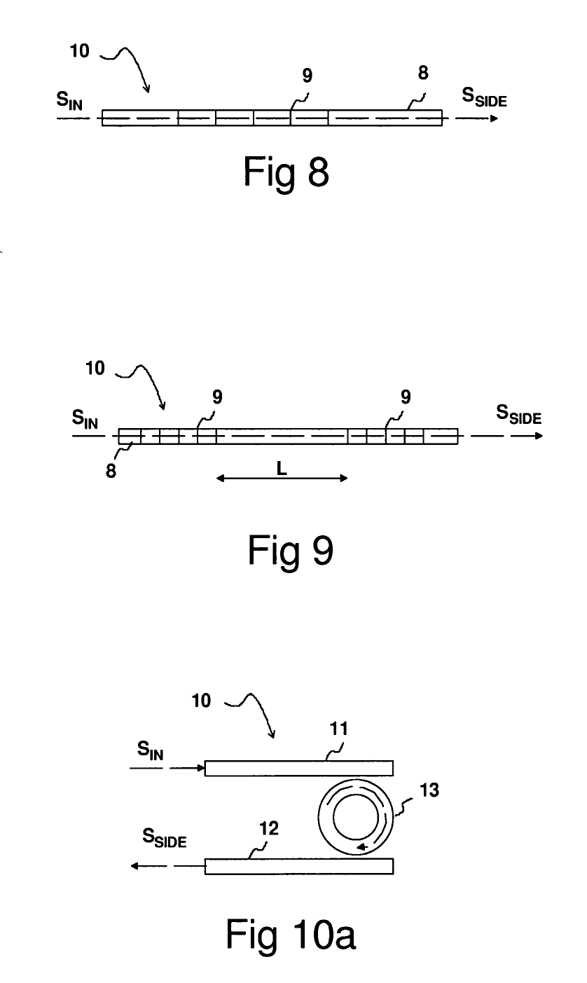

Referring to FIG. 8, the first resonator 10 and/or the second resonator 20 may be implemented using a fiber optic Bragg grating. The fiber optic Bragg grating comprises a portion of optical waveguide 8 comprising periodic features 9.

Referring to FIG. 9, the first resonator 10 and/or the second resonator 20 may be implemented using structure which comprises two Bragg gratings, said gratings defining a cavity between them.

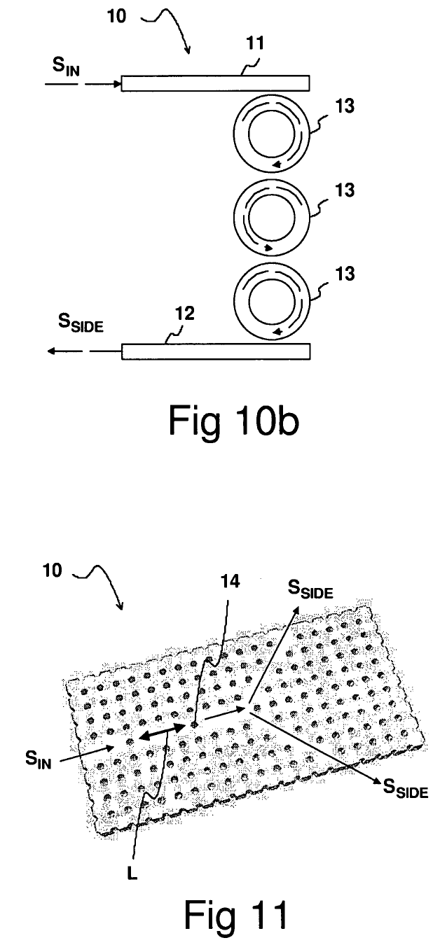

Referring to FIG. 10a, the first resonator 10 and/or the second resonator 20 may be implemented using a micro ring resonator. Waveguides 11, 12 may be arranged to couple light in and out from a micro ring 13, said micro ring 13 forming an optical resonator. Light may be coupled to and from the waveguides and other optical components, such as the ring resonators 13, by evanescent coupling.

Referring to FIG. 10b, the first resonator 10 and/or the second resonator 20 may be implemented using a plurality of optically coupled micro ring resonators.

Referring to FIG. 11, the first resonator 10 and/or the second resonator 20 may be implemented using light-scattering periodic microstructures 14. Also optical splitters or combiners may be implemented by the microstructures.

The first resonator 10 and/or the second resonator 20 may also be implemented using a resonator formed based on a fiber loop or a portion of a fiber defined between two reflectors (not shown).

The first resonator 10 and the second resonator 20 may be implemented using a birefringent structure, e.g. a cavity 7 comprising birefringent medium. Thus, two different optical lengths may be implemented simultaneously using a single physical unit. The input signal S_{IN} may be divided into two parts having e.g. vertical and horizontal polarizations inside the birefringent resonator. The optical length of the cavity 7 corresponding to the vertical polarization may be adjusted to provide a pass band at the carrier wavelength λ₀. The optical length of the cavity 7 corresponding to the horizontal polarization may be adjusted to provide a pass band at the sideband wavelength λ₁. The reference signal S_{REF} (FIGS. 6 and 7) is separated from the sideband signal S_{SIDE} after the resonator by use of a polarizing beam splitter, or a combination comprising one or more polarizers.

The first resonator 10 and/or the second resonator 20 may be used in the transmissive mode or in the reflective mode.

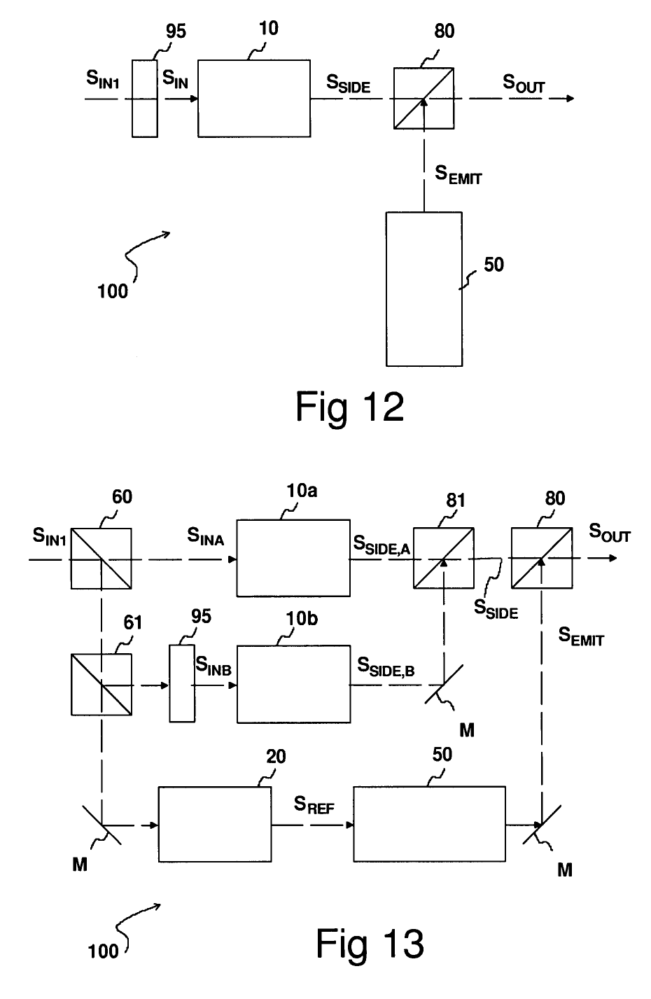

Referring to FIG. 12, the signal processing device 100 may comprise a polarization controlling element 95. The polarization controlling element 95 may be adapted to select a portion of input signal S_{IN} having a predetermined polarization, i.e. orientation of polarization. The polarization controlling element 95 is advantageously used when the input signal S_{IN} is unstable or unknown. The polarization controlling element 95 may also be adapted to change the polarization of the input signal S_{IN}. One or more polarization controlling elements 95 may be positioned before the first resonator 10, between the first resonator 10 and the combiner 80, or after the combiner 80. One or more polarization controlling elements 95 may also be positioned between the light source 50 and the combiner 80. One or more polarization controlling elements 95 may also be positioned between the first resonator 10 and the second resonator 20 (not shown). One or more polarization controlling elements 95 may also be positioned after the second resonator 20 (not shown). Also the combiner 80 may be a polarizing combiner.

The polarization controlling element 95 may be any type of polarizer or polarization controller known by the person skilled in the art. The polarization controlling element 95 may be a fiber-based polarization controller, a set of waveplates, a polarizing crystal, or a polarizing foil. The polarization controlling element 95 may comprise a combination of optical components.

Referring to FIG. 13, the signal processing device 100 may be adapted to provide insensitivity with regard to the polarization of an optical primary signal S_{IN1}. An optical primary signal S_{IN1} is first divided into two parts using beam splitters 60, 61. The parts have substantially perpendicular polarization. One part constitutes an optical signal S_{INA}, which is coupled to a resonator 10a. The polarization of the other part is rotated substantially 90 degrees by a polarization controlling element 95 to form an optical signal S_{INB} which is coupled to a resonator 10b. The resonators 10a, 10b are tuned substantially to the same wavelength. Two sideband signals S_{SIDE,A}, S_{SIDE,B} are provided, which are combined using a combiner 81 to provide a sideband signal S_{SIDE}. The polarization of the sideband signal S_{SIDE} is substantially insensitive with regard to the polarization of the optical primary signal (S_{IN1}). The sideband signal S_{SIDE} is combined with the emitted light S_{EMIT} to provide the optical output signal S_{OUT}. The signal processing device 100 may comprise a resonator 20 to select a wavelength which is coupled to the light emitting unit 50 to stabilize the wavelength.

A primary optical input signal S_{IN1} may be amplitude-modulated, phase-modulated, quadrature-modulated or modulated according to a further format known by the person skilled in the art. The primary optical input signal S_{IN1} may comprise data transmitted at several optical channels such that data transmitted at the different optical channels are modulated in different ways. The data rates associated with the different channels may be different.

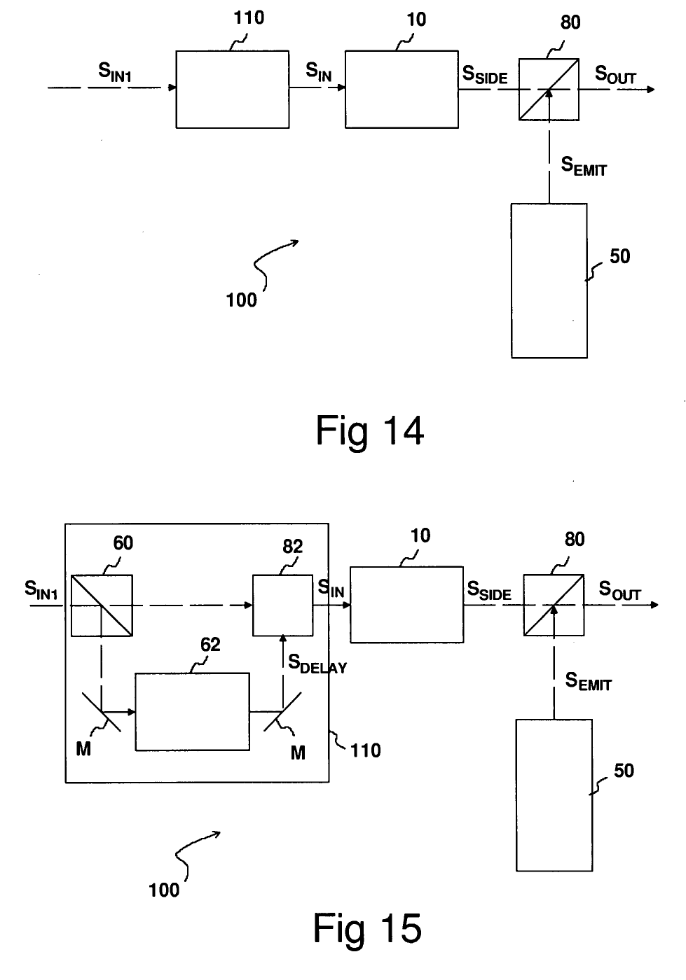

The primary optical input signal S_{IN1} may be modulated in such a way that it does not originally comprise spectral components corresponding to the clock. The primary optical input signal S_{IN1} may be modulated e.g. according to the non-return-to-zero (NRZ) format. Referring to FIG. 14, the signal processing device 100 may comprise a pre-processing unit 110 to provide an optical input signal S_{IN} which comprises spectral components associated with the clock frequency of the primary optical input signal S_{IN1}.

Referring to FIG. 15, the pre-processing unit 110 may comprise a delay line 62 and an optical combiner 82. The primary optical input signal S_{IN1} may be delayed and combined with the original undelayed primary optical input signal S_{IN1} to perform an exclusive-OR-operation of the delayed and undelayed signals. Consequently, an optical input signal S_{IN} may be provided which comprises frequency components associated with the clock frequency. Such an arrangement is disclosed e.g. in an article “All-Optical Clock Recovery from NRZ Data of 10 Gb/s”, by H. K. Lee, J. T. Ahn, M.-Y. Jeon, K. H. Kim, D. S. Lim, C.-H. Lee, IEEE Photonics Technology Letters, Vol. 11 No. 6 June 1999 pp. 730-732, herein incorporated by reference.

The pre-processing unit 110 may also be implemented by non-linear devices such as disclosed e.g. in U.S. Pat. No. 5,339,185.

Referring to FIGS. 16 and 5b, the signal processing device 100 may further comprise an output stabilization unit 85 to provide an output signal S_{OUT,STAB} which is stabilized and reshaped with respect with respect to the beat amplitude. The stabilization unit 85 may be based on an optical resonator exhibiting optical bistability. The stabilization unit 85 may be based on an optically saturable element. The stabilization unit 85 may be based on the use of one or more semiconductor optical amplifiers.

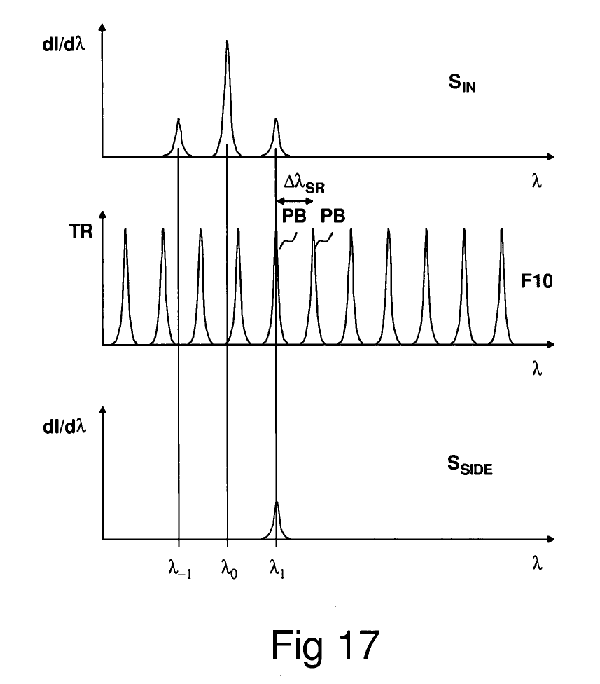

Referring to FIG. 17, the first resonator 10 may have several pass bands with a separation which is smaller than the separation between the carrier wavelength λ₀ and the wavelength λ₁ of the sideband.

The signal processing device 100 may be used in combination with optical data receivers, repeaters, transponders or other type of devices used in fiber optic networks. The signal processing device 100 may be used in combination with optical data receivers, repeaters, transponders or other type of devices used in optical communications systems operating in free air or in space.

The optical input signal S_{IN} may comprise data sent at several optical channels, i.e. associated with different carrier wavelengths. Carrier wavelengths for optical channels in fiber optic networks have been standardized e.g. by the International Telecommunication Union within the United Nations System. The separation between at least two carrier wavelengths (λ_{0,A}, λ_{0,B}) may be e.g. 100 GHz in the frequency domain.

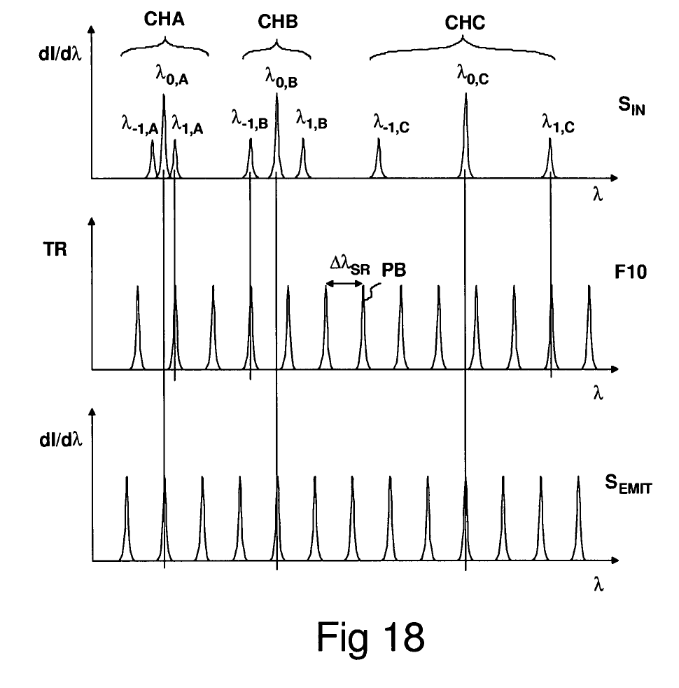

Referring to FIG. 18, the signal processing device 100 may be used to recover clock frequencies associated with several optical channels CHA, CHB, CHC. The uppermost curve of FIG. 18 shows the spectral components of an optical input signal S_{IN}, which comprises data sent at three optical channels CHA, CHB and CHC. There are three carrier wavelengths λ_{0,A}, λ_{0,B} and λ_{0,C} and six sideband wavelengths λ_{-1,A}, λ_{-1,A}, λ_{-1,B}, λ_{1, B}, λ_{-1,C}, λ_{1,C} corresponding to the modulation at three different clock frequencies.

The second curve F10 of FIG. 18 shows the pass bands PB of the first resonator 10. One of the pass bands is set at least approximately to the sideband wavelength λ_{1,A}, one of the pass bands is set at least approximately to the sideband wavelength λ_{1,B} and one of the pass bands is set at least approximately to the sideband wavelength λ_{1,C}.

Referring to the lowermost curve of FIG. 18, the emitted light S_{EMIT} is adapted to comprise spectral components at least at the three carrier wavelengths λ_{0,A}, λ_{0,B} and λ_{0,C}.

Combination of the transmitted sideband signal S_{SIDE} and the emitted light S_{EMIT} provides an output signal S_{OUT} which exhibits three beat terms. A first term exhibits beat at the clock frequency associated with the first optical channel CHA, a second beat term exhibits beat at the clock frequency associated with the second optical channel CHB, and a third term exhibits beat at the clock frequency associated with the third optical channel CHC. The output signal S_{OUT} may be further coupled to a wavelength demultiplexer to provide three separate optical signals, beating at the respective clock frequencies.

The pass bands PB of the first optical resonator 10 may be simultaneously adapted to correspond to a set of frequencies ν_{q} given by:

ν_{q}=ν_{0,A}+qΔν_{SR}+ν_{CLK,A}, (8)

or, alternatively, simultaneously given by:

ν_{q}=ν_{0,A}+qΔν_{SR}−ν_{CLK,A}, (9)

where q is an integer ( . . . −2, −1, 0, 1, 2, 3, . . . ), ν_{0,A} is the optical frequency (=c/nλ₀) corresponding to the carrier wavelength λ₀ of a predetermined optical channel A, Δν_{SR} is the separation between the pass bands of the first resonator 10 in the frequency domain and ν_{CLK,A} is the lowest clock frequency associated with said optical channel.

For example, the separation between the carrier wavelengths may be 100 GHz, the separation range Δν_{SR} may be 50 GHz and the lowest clock frequency ν_{CLK,A} may be 10 GHz. In that case the first resonator 10 may be adapted to simultaneously filter frequencies ν_{0,A}−140 GHz ν_{0,A}−90 GHz, ν_{0,A}−40 GHz, ν_{0,A}+10 GHz, ν_{0,A}+60 GHz, ν_{0,A}+110 GHz, ν_{0,A}+160 GHz, ν_{0,A}+210 GHz . . . . Consequently, several clock frequencies associated with different optical channels, i.e. associated with several carrier wavelengths may be recovered simultaneously, providing that the respective sidebands coincide with the pass bands of the first resonator 10. An example of a possible combination of carrier frequencies and clock frequencies is presented in Table 1.

TABLE 1
A possible combination of carrier frequencies, clock frequencies
and pass band positions, by way of example.

| Optical | Carrier | Clock | Positions of 1st | Positions of |
|---|---|---|---|---|
| Channel No. | frequency | frequency | resonator passbands | emitted light S_{EMIT} |
| 1 | ν_{0, A} − 200 GHz | 10 GHz | ν_{0, A} − 190 GHz | ν_{0, A} − 200 GHz |
| 2 | ν_{0, A} | 40 GHz | ν_{0, A} − 40 GHz | ν_{0, A} |
| 3 | ν_{0, A} + 200 GHz | 10 GHz | ν_{0, A} + 210 GHz | ν_{0, A} + 200 GHz |
| 4 | ν_{0, A} + 1000 GHz | 160 GHz | ν_{0, A} + 1160 GHz | ν_{0, A} + 1000 GHz |

The light source 50 is adapted to emit light S_{EMIT} at the respective carrier frequencies.

The separation range Δλ_{SR} of the first resonator 10 may be selected to be substantially equal to the minimum separation between adjacent carrier wavelengths λ_{0,A}, λ_{0,B} multiplied by an integer number.

A second resonator 20 may be used to stabilize the wavelengths of the light sources 50 (FIGS. 6 and 7). The separation range Δλ_{SR} of the second resonator 20 may be selected to be substantially equal to the minimum separation between adjacent carrier wavelengths λ_{0,A}, λ_{0,B} multiplied by an integer number.

It is emphasized that the channel separation need not be an integer multiple of the clock frequency. For comparison, in the above-mentioned approach by Jinno & al., the channel separation has to be an integer multiple of the clock frequency.

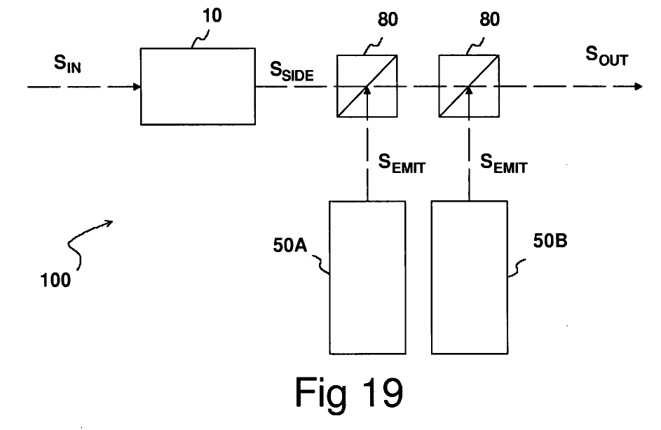

Referring to FIG. 19, the signal processing device may comprise two or more light sources 50A, 50B. Each light source 50A, 50B may emit light at one or more wavelengths, corresponding to the carrier wavelengths of a plurality of respective optical data transmission channels. The light emitted S_{EMIT} by the light sources 50A, 50B are combined with the sideband signal S_{SIDE} by the combiners 80 to provide the output signal S_{OUT}. The signal processing device 100 may further comprise a wavelength demultiplexer (not shown) to separate recovered optical clock signals associated with the different optical channels.

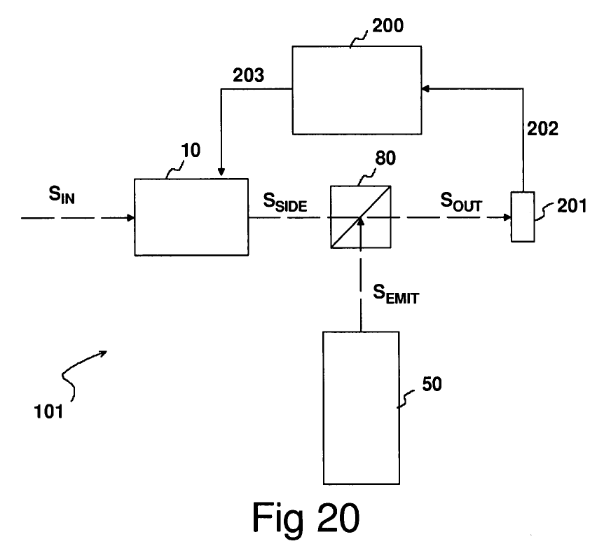

Referring to FIG. 20, The signal processing device 101 may be used for signal frequency component analysis of the optical input signal S_{IN}. In this embodiment the optical input signal S_{IN} need not be a data signal. E.g. the optical input signal S_{IN} may have a continuous spectrum and/or it may be a continuous wave signal. The signal processing device 101 further comprises an optical sensor 201 and a data acquisition unit 200. The optical sensor may be e.g. a photodiode with a suitable amplifier. The signal 202 may be transferred to the data acquisition unit 200 electronically or as a data signal. The data acquisition unit may 200 be a computer equipped with data acquisition capabilities. The data acquisition unit 200 may send a tuning signal 203 to the resonator to set the wavelength position of the resonator 10 to a predetermined wavelength position or to scan the wavelength position of the resonator 10 over a predetermined wavelength range.

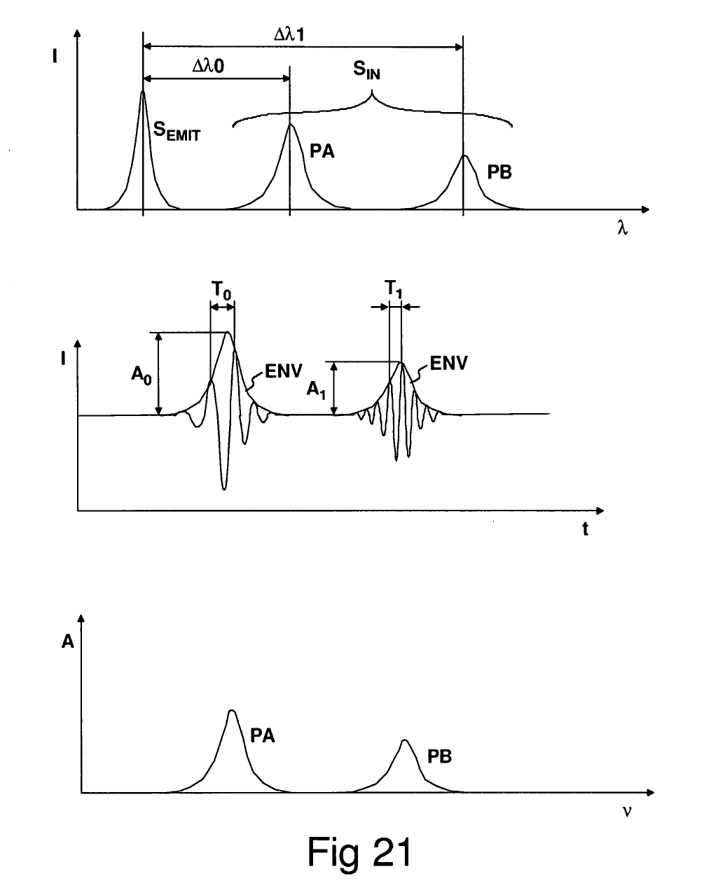

Referring to the upper curve in FIG. 21, the wavelength of the emitted light S_{EMIT} is preferably selected to be in the vicinity of said predetermined wavelength range, which includes the spectral peaks PA, PB of the optical input signal S_{IN}. The separations between the wavelength of the emitted light S_{EMIT} and the wavelengths of the spectral peaks PA, PB are Δλ0 and Δλ1. The wavelength separation is selected small enough such that a resulting beat amplitude can be monitored by devices and methods known by the person skilled in the art. The wavelength separation may be e.g. smaller than or equal to 20 GHz. The bandwidth of the input signal S_{IN} is advantageously smaller than the separation range Δλ_{SR} of the first resonator 10.

Combination of the filtered signal S_{SIDE} and the emitted light S_{EMIT} result as an output signal S_{OUT} which comprises a beating term. The amplitude and the frequency of the beating varies as the resonator is tuned over the predetermined wavelength range.

The amplitude and the frequency of the beat signal detected by the optical sensor are recorded by the data recording unit 200 during the scanning. The second curve in FIG. 21 shows schematically the recorded beat signal, an oscillogram, corresponding to the spectral peaks PA, PB. The envelope ENV of the oscillogram is also shown. The frequency of the beating corresponds to the difference between the resonator wavelength and the wavelength of the emitted light S_{EMIT} The amplitude of the beating is proportional to amplitude of the respective spectral component of the optical input signal S_{IN}. The amplitude of beating is marked by A₀ and A₁. T₀ and T₁ denote the cycle times.

The lowermost curve in FIG. 21 shows a plot of the modulation amplitude versus frequency corresponding to the spectral peaks PA, PB of the input signal S_{IN}. The plot gives directly the spectral analysis of the input signal S_{IN}.

The amplitude of the beat signal may also be plotted as a function of the wavelength position of the resonator 10, or as a function of the tuning signal 203, to provide spectral analysis of the input signal S_{IN}.

The signal processing device 100 may be implemented using fiber optic components.

The signal processing device 100 may be implemented using separate free-space optical components. The resonators 10, 20 may e.g. comprise a pair of dielectric-coated mirrors separated by a gas air, such as air, or vacuum.

The signal processing device 100 may be implemented with methods of integrated optics on a solid-state substrate using miniaturized components.

The cavity 7 of the first resonator 10 and/or the second resonator 20 may comprise transparent dielectric liquid and/or solid material.

The signal processing device 100 is understood to comprise optical paths between the optical components, said paths being implemented by free-space optical links, liquid or solid-state optical waveguides, and/or optical fibers.

The signal processing device 100 may further comprise light-amplifying means to amplify the input signal S_{IN}, the output signal S_{OUT}, the sideband signal S_{SIDE} and/or the reference signal S_{REF}. The light amplifying means may be implemented by e.g. rare-earth doped materials or waveguides. The light amplifying means may be a semiconductor optical amplifier.

For the person skilled in the art, it will be clear that modifications and variations of the signal processing devices and methods according to the present invention are perceivable. The particular embodiments described above with reference to the accompanying drawings and table are illustrative only and not meant to limit the scope of the invention, which is defined by the appended claims.

1-64. (canceled)

65. A device for processing of an optical input signal, the optical input signal comprising one or more carrier wavelengths, the device comprising:
a first optical resonator to provide a filtered signal by optical filtering of said optical input signal, said first optical resonator being non-matched with a predetermined carrier wavelength of said optical input signal;
one or more light sources to emit light at one or more wavelengths such that at least one wavelength of the emitted light is substantially equal to said predetermined carrier wavelength of said optical input signal; and
an optical combiner to combine said filtered signal with said emitted light to form an optical output signal.

66. The device according to the claim 65, wherein said device is adapted to recover at least one clock frequency associated with said optical input signal, one pass band of said first optical resonator being substantially matched with a first spectral component of said optical input signal, said first spectral component being associated with a first clock frequency of a signal sent at a first carrier wavelength.

67. The device according to the claim 66, wherein said device is adapted to recover a second clock frequency associated with said optical input signal, a further pass band of said first optical resonator being substantially matched with a second spectral component of said optical input signal, said second spectral component being associated with a second clock frequency of a signal sent at a second carrier wavelength.

68. The device according to claim 66, further comprising:
means to tune said first optical resonator to optimize the intensity of said filtered signal.

69. The device according to claim 66, wherein the wavelength position of at least one pass band of the first resonator is adjustable such that it may be adjusted to coincide with at least one sideband of said optical input signal.

70. The device according to claim 66, wherein at least one wavelength of said emitted light is adjustable.

71. The device according to claim 66, further comprising:
adjustment means to set the wavelength of the light source at least approximately to the carrier wavelength of said optical input signal.

72. The device according to claim 66, wherein at least one light source comprises an optical amplifier adapted to amplify light filtered by a second resonator.

73. The device according to claim 66, further comprising:
means to control the relative contribution of the optical input signal and the relative contribution of the emitted light to the optical output signal.

74. The device according to claim 66, further comprising:
an output stabilization unit to provide an output signal which is stabilized and/or reshaped with respect to a beat amplitude.

75. The device according to claim 66, further comprising:
a polarization controlling element to control the polarization of the optical input signal, said polarization controlling element being a component or a combination of components selected from the group of fiber-based polarization controller, set of waveplates, Wollaston prism, Glan-Focault polarizer, Nicol prism, Rochon prism, polarizer comprising dielectric coating, wire grid polarizer, polymer-based film polarizer, fiber transmitting single polarization mode only, and photonic crystal polarization separator.

76. The device according to claim 66, further comprising:
a pre-processing unit to provide said optical input signal by generating further spectral components from a modulated primary optical input signal.

77. The device according to the claim 76, wherein said pre-processing unit is configured to generate further spectral components from a primary optical input signal which is modulated according to the non-return-to-zero format.

78. The device according to the claim 76, wherein said pre-processing unit comprises a beam splitter to divide said primary optical input signal into at least two parts, a delay line to delay said primary optical input signal, and an optical combiner, said primary optical input signal and the delayed primary optical input signal being coupled to the inputs of said combiner such that said pre-processing unit performs an exclusive-OR operation of said primary optical input signal and said delayed primary optical input signal.

79. The device according to claim 66, further comprising:
a second optical resonator, wherein the first optical resonator and the second optical resonator filter two substantially perpendicular polarizations of an optical primary signal in order to provide insensitivity with regard to the polarization of said optical primary signal, and wherein the first optical resonator and the second optical resonator are tuned substantially to the same wavelength.

80. A method for processing of an optical input signal, which optical input signal has one or more carrier wavelengths, the method comprising:
optical filtering of said optical input signal to provide a filtered signal by using an optical resonator, said resonator being non-matched with a predetermined carrier wavelength of said optical input signal;
providing emitted light by using a light source at a wavelength which is substantially equal to said predetermined carrier wavelength of said optical input signal; and
optically combining said filtered signal with said emitted light to form an optical output signal.

81. The method according to the claim 80, further comprising:
recovering at least one clock frequency associated with said optical input signal, one pass band of said optical resonator being substantially matched with a first spectral component of said optical input signal, said first spectral component being associated with a first clock frequency of a signal sent at a first carrier wavelength.

82. The method according to the claim 81, further comprising:
recovering a second clock frequency associated with said optical input signal, a further pass band of said optical resonator being substantially matched with a second spectral component of said optical input signal, said second spectral component being associated with a second clock frequency of a signal sent at a second carrier wavelength.

83. The method according to claim 81, wherein said optical input signal comprises at least one component which is phase-modulated.

84. The method according to claim 81, further comprising:
pre-processing of an optical primary signal to form said optical input signal such that said optical input signal comprises at least one optical frequency component dependent on the clock frequency, said optical primary signal being modulated according to the non-return-to-zero format.

85. The method according to the claim 84, wherein said pre-processing comprises delaying said optical primary signal to form a delayed signal, and combining the delayed signal and the optical primary signal such that an exclusive-OR operation of said optical primary signal and said delayed signal is performed.

86. The method according to claim 82, wherein at least two optical channels of said optical input signal have different clock frequencies.

87. The method according to claim 81, wherein said optical input signal consists of data sent at substantially one wavelength only.

88. The method according to claim 81, further comprising:
analyzing frequency components of said optical input signal.
